(19) United States
(12) Patent Application Publication
(10) Pub. No.: US 2012/0000441 A1
(43) Pub. Date: Jan. 5, 2012

(54) DIESEL ENGINE FOR VEHICLE

(75) Inventors: Eiji Nakai, Hiroshima-shi (JP); Sadaharu Matsumoto, Higashihiroshima-shi (JP); Naotoshi Shirahashi, Hiroshima-shi (JP); Shinichi Morinaga, Hiroshima-shi (JP)

(73) Assignee: Mazda Motor Corporation, Hiroshima (JP)

(21) Appl. No.: 13/160,871

(22) Filed: Jun. 15, 2011

(30) Foreign Application Priority Data
Jun. 30, 2010 (JP) 2010-150151

(51) Int. Cl. F02D 41/30; F02M 51/00

(52) U.S. Cl. 123/299

(57) ABSTRACT

A diesel engine for a vehicle comprises an engine body mounted in the vehicle having a plurality of cylinders that is supplied with fuel, a plurality of fuel injection valves for directly injecting the fuel into the cylinders, and an injection control module for controlling a mode of injecting the fuel into the cylinders through the fuel injection valves. The injection control module sets a fuel injection amount per cylinder at least according to a load on the engine body, performs a main injection, and performs at least one pre-injection where fuel is injected prior to the main injection. The injection control module further executes a cylinder-cutoff operation mode where the fuel supplies to the cylinder or the cylinders are stopped when the engine body is under a low load condition where the fuel injection amount per cylinder is below a predetermined amount.

### BACKGROUND

The present invention relates to a diesel engine for a vehicle, and particularly relates to a control of a fuel injection in the diesel engine for the vehicle.

In a diesel engine of a vehicle, fuel injection is performed in each of one or more cylinders more than once during one cycle of the engine in order to, for example, reduce NOx and soot contained in exhaust gas, reduce noise or vibration, and improve fuel consumption and torque. For example, JP2009-293383A discloses a diesel engine that performs fuel injection at five time intervals, as follows: a main injection for generating a torque, a pilot injection performed prior to the main injection so as to preheat the cylinders, a pre-injection performed between the pilot injection and the main injection so as to suppress an ignition delay of fuel injected by the main injection, an after injection performed after the main injection so as to raise a temperature of exhaust gas, and a post injection for raising a temperature of a catalyst by directly introducing fuel to an exhaust system subsequent to the after injection.

Meanwhile, a geometric compression ratio of the diesel engine is commonly within a range of 15:1 to 17:1, particularly the latter half of 15:1 to 17:1. By decreasing the compression ratio to, for example, below 15:1, an exhaust emission performance and a thermal efficiency are expected to improve. On the other hand, a problem arises in which fuel ignition efficiency inside the cylinders is degraded when utilizing an engine with the lower compression ratio.

Here, the inventors of the present invention have found that in a diesel engine with the lower compression ratio, by having a pre-combustion with a predetermined peak heat release rate at a predetermined timing, before a top dead center of a compression stroke, caused by a single pre-injection (preferably more than once), an ignition delay of fuel that is injected by the main injection can be shortened and the main combustion can be stabilized.

However, the inventors of the present invention have also found that the fuel injection mode containing the above described pre-injection and main injection cannot maintain the stabilized state of the main combustion within an operation range where a load on the engine becomes low and a fuel injection amount is decreased.

### SUMMARY

The present invention is made in view of the above conditions and provides a diesel engine for a vehicle that can stabilize combustions in cylinders within a low load range where a fuel injection amount is decreased.

Through studies of the instability of the combustion within a low load range, the inventors of the present invention have found that reduction in the fuel injection amount due to the reduction in the engine load causes a reduction in the amount of fuel to be injected by the pre-injection between the pre-injection and the main injection. That is, the pre-combustion cannot occur at a sufficient heat release rate because the fuel injection amount in the pre-injection is reduced. As a result, the ignition delay of the fuel injected in the main injection becomes longer, and thereby the main combustion becomes destabilized. Particularly in an engine with the lower compression ratio, because a setting of the fuel injection amount is decreased as thermal efficiency improves, the fuel injection amount is further decreased when the engine load is reduced, and thereby further increasing instability of the main combustion.

For this reason, in order to effectively cause the pre-combustion to occur with a sufficient heat release rate, a cylinder-cutoff operating mode is executed, where the fuel supplies to one or more of the cylinders are stopped; and, the fuel injection amount per cylinder is increased for the one or more of the cylinders to be supplied with the fuel within the low load range, where the fuel injection amount becomes less than a predetermined amount.

According to one aspect of the invention, a diesel engine for a vehicle is provided, which includes an engine body to be mounted in the vehicle and having a plurality of cylinders that are supplied with fuel containing diesel fuel as its main component, a plurality of fuel injection valves arranged in the engine body so as to be oriented toward the cylinders and for directly injecting the fuel into the cylinders, respectively, and an injection control module for controlling a mode of injecting the fuel into the cylinders through the fuel injection valves.

The injection control module sets a fuel injection amount per cylinder according to at least a load on the engine body, performs a main injection where the fuel is injected at near a top dead center in a compression stroke so as to cause a main combustion that is largely triggered by a diffusion combustion, and performs, at least once, a pre-injection where the fuel is injected prior to the main injection so as to cause a pre-combustion having a peak of heat release rate at a predetermined timing before the top dead center in the compression stroke. The injection control module further executes a cylinder-cutoff operation mode, where the fuel supplies to the cylinder or the cylinders are stopped when the engine body is under a low load condition and the fuel injection amount per cylinder is below a predetermined amount.

Here, a pre-combustion having a peak heat release rate at a predetermined timing before the top dead center in the compression stroke includes a case in which, after the heat release rate rises to reach the peak before the top dead center in the compression stroke, the heat release rate falls and then rises due to the main combustion, and a case in which the heat release rate minimally falls after it rises to reach the peak in advance, the rise due to the main combustion.

Thus, the pre-combustion having the peak of heat release rate at the predetermined timing before the top dead center in the compression stroke is caused by performing the pre-injection at least once prior to the main injection, where the fuel is injected at near the top dead center in the compression stroke. Here, the pre-injection is preferably performed at a timing where at least a part of the injected fuel reaches cavities formed on top surfaces of pistons inserted into the cylinders. Further, it is preferable that substantially the full amount of the fuel injected by the pre-injection reaches the cavities. Furthermore, the pre-injection is preferably performed a plurality of times and the greater the number of the pre-injections, the more preferable, in view of locally enriching the fuel inside the cavities and improving an ignition efficiency.

The one or more pre-injections causes the pre-combustion having the peak of heat release rate at the predetermined timing before the top dead center in the compression stroke, and an ignition delay of the fuel injected in the main injection can be shortened and a stability following the main combustion can be improved by the pre-combustion.

When the engine body is under the low load condition where the fuel injection amount per cylinder is below the predetermined amount, the amount of fuel injected in the pre-injection is reduced, and thereby, the pre-combustion with a sufficient heat release rate cannot occur, the ignition delay of the fuel injected by the main injection becomes longer, the ignition efficiency is degraded, and the heat release is suppressed. In other words, the main combustion is destabilized. Therefore, as described above, a cylinder-cutoff operation mode may be implemented, where the fuel supply to the cylinder or cylinders is stopped when the engine body is under the low load condition. Thereby, the fuel injection amount for each of the cylinders that is supplied with the fuel is increased such that a sufficient fuel injection amount can be surely delivered during the pre-injection. As a result, the pre-combustion with a sufficient heat release rate can occur at the predetermined timing before the top dead center before the compression stroke, the ignition delay of the fuel injected by the main injection can be shortened, and the main combustion can be stabilized.

The diesel engine differs from a spark ignition engine in that intake air is basically not throttled. Therefore, an indicator wave (motoring wave) is formed as a result of the compression of the air inputted into the cylinders. On the other hand, the cylinder-cutoff operating mode is executed when the engine body is under the low load, and an increase of a cylinder internal pressure via combustion in the cylinder during operation is small. Therefore, the motoring waveform becomes dominant within the change of the indicator waveform, and the change of the indicator waveform become substantially regular. Thus, a noise, vibration, and harshness (NVH) performance can avoid degradation in the cylinder-cutoff operating mode.

The predetermined amount may be set, under a condition that the fuel is supplied to each of the cylinders, based on a summation of a minimum injection amount of the pre-injection required for causing the pre-combustion with a predetermined heat release rate and a minimum injection amount of the main injection required for causing a combustion torque corresponding to the load on the engine body by the diffusion combustion.

In other words, by setting the predetermined amount relating to the fuel injection, which is a threshold relating to determining whether to execute the cylinder-cutoff operation mode, based on the summation of the minimum injection amount of the pre-injection and the main injection (the summation may be set as the predetermined amount as is), the pre-combustion with a sufficient heat release rate occurs so that a required combustion torque can be achieved by the main combustion while the main combustion is stabilized.

A geometric compression ratio of the engine body may be set within a range of 12:1 to below 15:1.

In other words, in the view of stabilizing the main combustion within the low load range, the cylinder-cutoff operation mode is particularly effective in an engine body where the ignition efficiency is comparatively low due to the low compression ratio and a setting of the fuel injection amount is decreased due to the increase of the heat release rate.

Each time the cylinder-cutoff operation mode is executed, the injection control module may alternate the cylinder or cylinders that are not to be supplied with the fuel.

Because the combustion does not occur while the fuel supply to the cylinder or cylinders is stopped, the temperature in the cylinder or cylinders drops. Therefore, required conditions for executing the cylinder-cutoff operating mode are not met, and, when the operation mode is changed back to the normal mode, the fuel supplied to the cylinder or cylinders which were deactivated is difficult to ignite or does not ignite because the temperature in the cylinder or cylinders is too low.

For this reason, by alternating the cylinder or cylinders that are not supplied with fuel, it can be avoided that a cylinder remains deactivated and the temperature in the cylinder significantly decreases.

The injection control module may execute the cylinder-cutoff operation mode when a rotation speed of the engine body is above a predetermined value.

When the engine body is within a high speed range where a speed thereof is above a predetermined value, the crank angle velocity becomes high, the plurality of pre-injections become difficult to perform because a time interval between the pre-injections becomes shorter. In other words, the number of the pre-injections must be reduced within the high speed range; however, this reduction causes degradation of the ignition efficiency in the cylinders. As a result, the pre-combustion becomes difficult to be caused, the heat release rate is suppressed, and the main combustion is destabilized.

Therefore, executing the cylinder-cutoff operation mode when the engine body is under the low load and high speed is particularly effective in avoiding instability of the pre-combustion and the main combustion.

According to another aspect of the invention, a diesel engine for a vehicle is provided, which includes an engine body to be mounted in the vehicle and having a plurality of cylinders that are supplied with fuel containing diesel fuel as its main component, a plurality of fuel injection valves arranged in the engine body so as to be oriented toward the cylinders and for directly injecting fuel into the cylinders, respectively, and an injection control module for controlling a mode of injecting the fuel into the cylinders through the fuel injection valves. A geometric compression ratio of the engine body is set within a range of 12:1 to below 15:1.

The injection control module sets a fuel injection amount per cylinder at least according to a load on the engine body, performs a main injection where the fuel is injected at near a top dead center in a compression stroke so as to cause a main combustion that is largely triggered by a diffusion combustion, and performs, at least once, a pre-injection where the fuel is injected prior to the main injection so as to cause a pre-combustion having a peak heat release rate at a predetermined timing before the top dead center in the compression stroke. The injection control module further executes a cylinder-cutoff operation mode where the fuel supply to one or more of the cylinders is stopped when the engine body is under a low load condition, where the fuel injection amount per cylinder is below a predetermined amount. The predetermined amount is set, under a condition that fuel is supplied to all of the cylinders, based on a summation of a minimum injection amount of the pre-injection required for causing the pre-combustion with a predetermined heat release rate and a minimum injection amount of the main injection required for causing a combustion torque corresponding to the load on the engine body by the diffusion combustion.

### BRIEF DESCRIPTION OF THE DRAWINGS

FIG. 1 is a schematic diagram showing a configuration of a diesel engine according to one embodiment.

FIG. 2 is a block diagram relating to a control of the diesel engine.

FIG. 3 includes two charts, where part (a) is an example of a fuel injection mode within a predetermined operation range and part (b) is an example of a history of a heat release rate according to the fuel injection mode.

FIG. 4 is a chart showing relations between an engine speed and minimum injection amounts of fuel required per cylinder.

FIG. 5 is a diagram illustrating a cylinder deactivation operation when two of the four cylinders are deactivated.

FIG. 6 is a chart of an example of an indicator chart under a two-cylinder operation.

FIG. 7 is a diagram illustrating a cylinder deactivation operation when one of the four cylinders is deactivated.

FIG. 8 is a diagram illustrating a cylinder deactivation operation when a single cylinder is deactivated at every predetermined cycle.

### DESCRIPTION OF EMBODIMENT

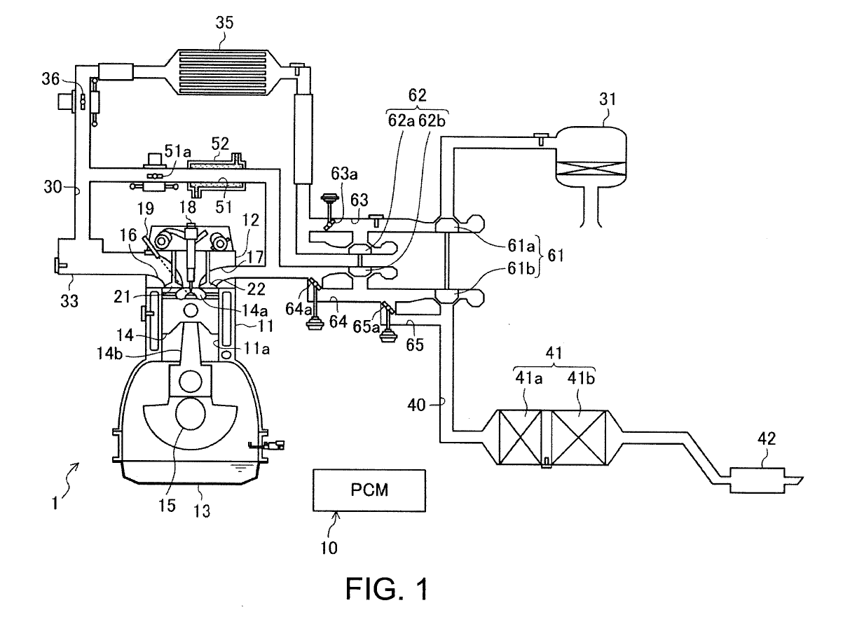

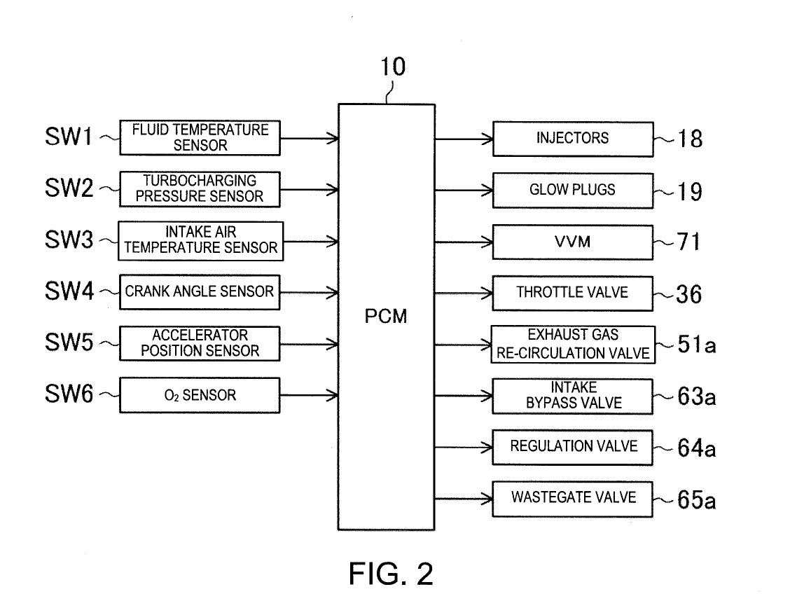

Hereinafter, a diesel engine according to an embodiment of the present invention is described in detail with reference to the appended drawings. Note that, the following description of the preferred embodiment is merely an illustration. FIGS. 1 and 2 show schematic configurations of an engine 1 (engine body) of the embodiment. The engine 1 is a diesel engine that is mounted in a vehicle and supplied with fuel in which a main component is diesel fuel. The diesel engine includes a cylinder block 11 provided with a plurality of cylinders 11a (although only one cylinder is illustrated in the drawings, the engine of the present embodiment is an in-line four cylinder engine having first to fourth cylinders), a cylinder head 12 arranged on the cylinder block 11, and an oil pan 13 arranged below the cylinder block 11, where a lubricant is stored. Inside the cylinders 11a of the engine 1, pistons 14 are reciprocatably inserted, and cavities partially forming reentrant combustion chambers 14a are formed on top surfaces of the pistons 14, respectively. Each of the pistons 14 is coupled to a crank shaft 15 via a connecting rod 14b.

In the cylinder head 12, an intake port 16 and an exhaust port 17 are formed and an intake valve 21 and an exhaust valve 22 for opening and closing the openings of the intake port 16 and the exhaust port 17 are arranged on each side of the combustion chambers 14a for each of the cylinders 11a.

Within a valve system of the engine 1 for operating the intake and exhaust valves 21 and 22, a hydraulically-actuated switching mechanism 71 (see FIG. 2, hereinafter, it is referred to as VVM, variable valve motion) for switching an operation mode of the exhaust valve 22 between a normal mode and a special mode is provided on the exhaust valve side. The VVM 71 (a detailed configuration is not illustrated) includes a first cam having one cam nose and a second cam having two cam noses, that are two kinds of cams with cam profiles different from each other, and a lost motion mechanism for selectively transmitting an operation state of either one of the first and second cams to the exhaust valve 22. When the lost motion mechanism transmits the operation state of the first cam to the exhaust valve 22, the exhaust valve 22 operates in the normal mode and opens only once during an exhaust stroke. On the other hand, when the lost motion mechanism transmits the operation state of the second cam to the exhaust valve 22, the exhaust valve 22 operates in the special mode and opens during the exhaust stroke and opens again during an intake stroke, and thus the exhaust valve is opened twice.

The mode switching in the VVM 71 between the normal and special modes is performed by a hydraulic pressure applied by a hydraulic pump (not illustrated) operated by the engine. The special mode may be utilized for a control related to an internal EGR. Note that, an electromagnetically-operated valve system for operating the exhaust valve 22 by using an electromagnetic actuator may be adopted for switching between the normal mode and the special mode. Further, the execution of the internal EGR is not limited to opening the exhaust valve 22 twice, and it may be accomplished through an internal EGR control by opening the intake valve 21 twice, or through an internal EGR control where the burnt gas remains in the combustion chambers by setting a negative overlap period through closing both of the intake and exhaust valves 21 and 22 during the exhaust stroke or the intake stroke.

Injectors 18 for injecting the fuel and glow plugs 19 for improving an ignition efficiency of the fuel by heating intake air under a cold state of the engine 1 are provided within the cylinder head 12. The injectors 18 are arranged so that fuel injection ports thereof face the combustion chambers 14a from ceiling surfaces of the combustion chambers 14a, respectively, and basically, the injectors 18 supply the fuel to the combustion chambers 14a by directly injecting the fuel at the point near the top dead center in a compression stroke.

An intake passage 30 is connected to a side surface of the engine 1 so as to communicate with the intake ports 16 of the cylinders 11a. Meanwhile, an exhaust passage 40 for discharging the burnt gas (exhaust gas) from the combustion chambers 14a of the cylinders 11a is connected to the other side surface of the engine 1. Intake passage 30 and exhaust passage 40 are arranged with a large turbocharger 61 and a compact turbocharger 62 for turbocharging the intake air (described in detail below).

An air cleaner 31 for filtrating the intake air is arranged in an upstream end part of the intake passage 30. A surge tank 33 is arranged near a downstream end of the intake passage 30. A part of the intake passage 30 on the downstream side of the surge tank 33 is branched to be independent passages extending toward the respective cylinders 11a, and downstream ends of the independent passages are connected with the intake ports 16 of the cylinders 11a.

A compressor 61a of the large turbocharger 61, a compressor 62a of the compact turbocharger 62, an intercooler 35 for cooling air compressed by the compressors 61a and 62a, and a throttle valve 36 for adjusting an intake air amount for the combustion chambers 14a of the cylinders 11a are arranged in the intake passage 30 between the air cleaner 31 and the surge tank 33. The throttle valve 36 is generally fully opened; however, it is fully closed when the engine 1 is stopped so as to prevent shock.

A part of the exhaust passage 40 on the upstream side is constituted with an exhaust manifold having independent passages branched toward the cylinders 11a and connected with outer ends of the exhaust ports 17 and a merging part where the independent passages merge together.

In a portion of the exhaust passage 40 on the downstream of the exhaust manifold, a turbine 62b of the compact turbocharger 62, a turbine 61b of the large turbocharger 61, an exhaust emission control device 41 for purifying hazardous components contained in the exhaust gas, and a muffler 42 are arranged in this order from the upstream.

The exhaust emission control device 41 includes an oxidation catalyst 41a and a diesel particulate filter 41b (hereinafter, referred to as the filter), and these components are arranged in this order from the upstream. The oxidation catalyst 41a and the filter 41b are accommodated in a case. The oxidation catalyst 41a has an oxidation catalyst carrying, for example, platinum or platinum added with palladium and promotes a reaction generating CO₂ and H₂O by oxidizing CO and HC contained in the exhaust gas. The filter 41b catches particulates such as soot contained in the exhaust gas from the engine 1. Note that the filter 41b may be coated with the oxidation catalyst.

A part of the intake passage 30 between the surge tank 33 and the throttle valve 36, which is a part downstream of the compact compressor 62a of the compact turbocharger 62, and a part of the exhaust passage 40 between the exhaust manifold and the compact turbine 62b of the compact turbocharger 62, which is a part upstream of the compact turbine 62b of the compact turbocharger 62, are connected with an exhaust gas re-circulation passage 51 for partially re-circulating the exhaust gas to the intake passage 30. An exhaust gas re-circulation valve 51a for adjusting a re-circulation amount of the exhaust gas to the intake passage 30, and an EGR cooler 52 for cooling the exhaust gas by engine coolant are arranged in the exhaust gas re-circulation passage 51.

The large turbocharger 61 has the large compressor 61a arranged in the intake passage 30 and the large turbine 61b arranged in the exhaust passage 40. The large compressor 61a is arranged in the intake passage 30 between the air cleaner 31 and the intercooler 35. The large turbine 61b is arranged in the exhaust passage 40 between the exhaust manifold and the oxidation catalyst 41a.

The compact turbocharger 62 has the compact compressor 62a arranged in the intake passage 30 and the compact turbine 62b arranged in the exhaust passage 40. The compact compressor 62a is arranged in the intake passage 30 on the downstream of the large compressor 61a. The compact turbine 62b is arranged in the exhaust passage 40 on the upstream of the large turbine 61b.

In other words, the large compressor 61a and the compact compressor 62a are arranged in series in the intake passage 30 in this order from upstream of the large turbocharger 61, and the compact turbine 62b and the large turbine 61b are arranged in series in the exhaust passage 40 in this order from downstream of the cylinder head 12. The large turbine 61b and the compact turbine 62b are rotated by the flow of the exhaust gas, and the large compressor 61a and the compact compressors 62a coupled with the large turbine 61b and the compact turbine 62b are actuated by the rotation of the large turbine 61b and compact turbine 62b, respectively.

The compact turbocharger 62 is smaller and the large turbocharger 61 is larger in relation to each other. Thus, inertia of the large turbine 61b of the large turbocharger 61 is larger than that of the compact turbine 62b of the compact turbocharger 62.

A small intake bypass passage 63 for bypassing the small compressor 62a is connected with the intake passage 30. A small intake bypass valve 63a for adjusting an amount of the air flowing into the small intake bypass passage 63 is arranged in the small intake bypass passage 63. The small intake bypass valve 63a is normally fully closed when no electric power is distributed thereto.

A small exhaust bypass passage 64 for bypassing the small turbine 62b and a large exhaust bypass passage 65 for bypassing the large turbine 61b are connected with the exhaust passage 40. A regulation valve 64a for adjusting an amount of the exhaust gas flowing to the small exhaust bypass passage 64 is arranged within the small exhaust bypass passage 64, and a wastegate valve 65a for adjusting an exhaust gas amount flowing to the large exhaust bypass passage 65 is arranged in the large exhaust bypass passage 65. The regulation valve 64a and the wastegate 65a are both fully opened (normally opened) when no electric power is distributed thereto.

The diesel engine 1 with the configuration described as above is controlled by a powertrain control module 10 (hereinafter referred to as PCM). The PCM 10 is configured by a CPU, a memory, a counter timer group, an interface, and a microprocessor with paths for connecting these units. The PCM 10 is configured to be a control device. As shown in FIG. 2, the PCM 10 is inputted with detection signals from a fluid temperature sensor SW1 for detecting a temperature of an engine coolant, a turbocharging pressure sensor SW2 attached to the surge tank 33 for detecting a pressure of the air to be supplied to the combustion chamber 14a, an intake air temperature sensor SW3 for detecting a temperature of the intake air, a crank angle sensor SW4 for detecting a rotational angle of the crank shaft 15, an accelerator position sensor SW5 for detecting an accelerator opening amount corresponding to an angle of an acceleration pedal (not illustrated) of the vehicle, and an O₂ sensor SW6 for detecting an oxygen concentration within the exhaust gas. The PCM 10 performs various calculations based on the detection signals so as to determine the states of the engine 1 and the vehicle, and further outputs control signals to the injectors 18, the glow plugs 19, the VVM 71 of the valve system, and the actuators of the valves 36, 51a, 63a, 64a and 65a according to the determined states.

Thus, the engine 1 is configured to have a comparatively low compression ratio where the geometric compression ratio is within a range of 12:1 to below 15:1, and thereby the exhaust emission performance is improved and a thermal efficiency is improved. The large and small turbochargers 61 and 62 increase a torque of the engine 1 so as to compensate the power that is lost by the low geometric compression ratio. Note that, the geometric compression ratio of the engine 1 is not limited to this.

### (Description of Combustion Control of the Engine)

In the basic control of the engine 1 by the PCM 10, a target torque (target load) is determined mainly based on the accelerator opening amount, and an injection amount and an injection timing of the fuel corresponding to the target torque is realized by controlling the actuations of the injectors 18. Further, a re-circulation ratio of the exhaust gas to the cylinders 11a is controlled by controlling the opening angles of the throttle valve 36 and the exhaust gas re-circulation valve 51a (external EGR control), and controlling the VVM 71 (internal EGR control).

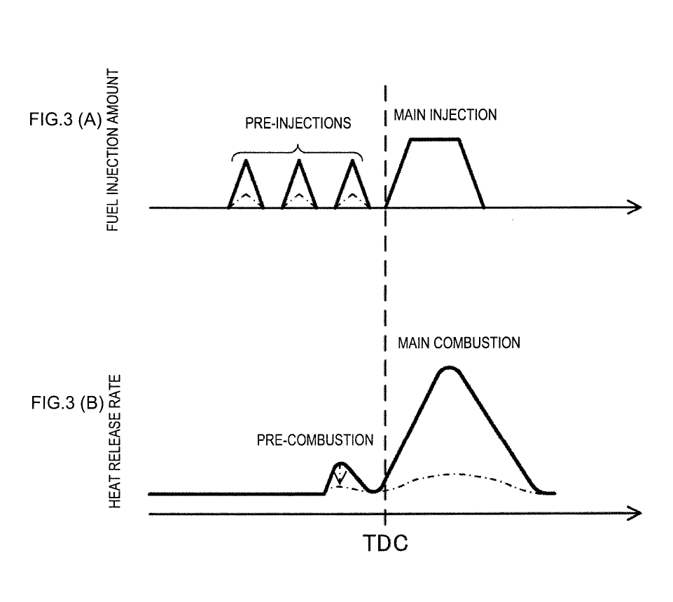

In the engine 1, a plurality of operation ranges are partitionally set according to the engine speed and the engine load (actual total injection amount of the fuel), and different fuel injection modes are set for each operation range. FIG. 3 includes two charts, where the part (a) is an example of the fuel injection mode within the operation range of a comparatively low load and the part (b) is an example of a history of a heat release rate inside the cylinders 11a according to the fuel injection mode. As indicated by the solid line in part (a) of FIG. 3, in the fuel injection mode within this range, pre-injections are performed three times for each of the cylinders 11 with comparatively short time intervals at a timing comparatively close to the top dead center in the compression stroke, and then a main injection is performed once near the top dead center in the compression stroke. Thus, a total of four fuel injections is performed within the operation range.

Here, the three pre-injections are performed so that at least a part of the injected fuel, preferably substantially the full amount of the injected fuel, reaches the cavity formed in the piston 14. Thereby, the fuel can locally be enriched inside the cavity. Further, as indicated by the solid line in part (b) of FIG. 3, the pre-injections cause a pre-combustion having a predetermined heat release rate at a predetermined timing before the top dead center in the combustion stroke (e.g., BTDC5° CA). Thereby, in the diesel engine 1 where the ignition efficiency in the cylinders 11a is degraded because the compression ratio is set comparatively low, an ignition delay of the fuel injected by the main injection can be shortened and a stability of a following main combustion can be improved. Further, the pre-combustion may be effective in abating a rise of the heat release rate so as to reduce combustion noise and improve NVH performance.

In the range where the load on the engine 1 is further reduced, the total fuel injection amount (total of the injection amounts in the pre-injection and the main injection) per cylinder is reduced corresponding to the reduction of the load. Particularly, because the thermal efficiency is improved due to the low compression ratio and the total fuel injection amount in the engine 1 is set lower in advance, the total fuel injection amount further becomes less as a result of the load reduction. Here, because the fuel injection amount in the main injection is set to fulfill a required torque, the fuel injection amount in each of the pre-injections is relatively less corresponding to the reduced amount of the total fuel injection amount as indicated by, for example, the dashed-dotted line in part (a) of FIG. 3. Thereby, as indicated by the dashed-dotted line in part (b) of FIG. 3, the heat release rate of the pre-combustion is decreased, and thus the ignition delay of the fuel injected by the main injection becomes longer, the ignition efficiency is degraded, and the heat release is suppressed. In other words, the main combustion is destabilized.

Particularly, because the crank shaft angular velocity becomes faster as the engine speed becomes faster and the time interval between the pre-injections becomes shorter, the number of the pre-injections is reduced so as to permit the interval between the injections. However, as described above, because the plurality of pre-injections improves the ignition efficiency by locally enriching the fuel inside the cavity, the reduction in the number of the pre-injections causes a further degradation of the ignition efficiency. Thus, the above described pre-combustion becomes more difficult and the instability of the main combustion is increased as the engine speed increases when the engine load is low and the total fuel injection amount is less than a predetermined amount. Such an operation state of the engine 1 corresponds to a state where the vehicle is traveling on, for example, a flat or declining road at a substantially constant vehicle velocity.

Therefore, when the load on the engine 1 is low and the total fuel injection amount is reduced, a cylinder-cutoff operating mode where the fuel injection amount per cylinder is increased by reducing the number of the cylinders to be supplied with the fuel (specifically, reducing the number of the cylinders to be supplied with the fuel from four to two) is executed in the engine 1.

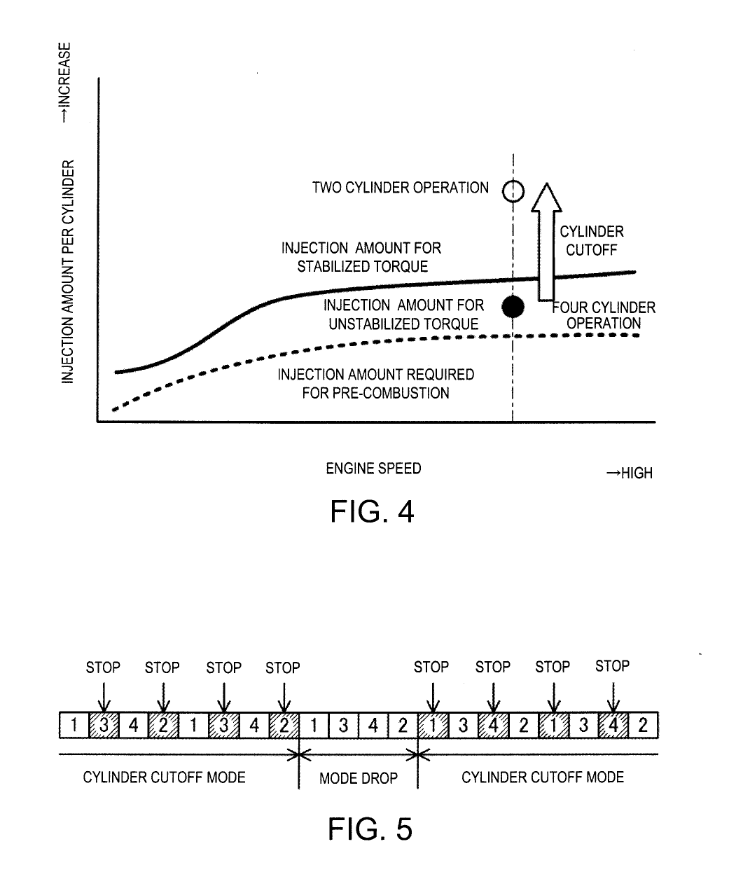

Specifically, when the total fuel injection amount (fuel injection amount per cylinder when the fuel is supplied to all the four cylinders) is set according to, for example, the engine load, the PCM 10 compares the fuel injection amount with the predetermined amount set in advance. Here, as shown in FIG. 4, the predetermined amount may be set as the total amount of a minimum fuel injection amount in the pre-injections required for the pre-combustion to occur (see the dashed line in FIG. 4) and a minimum fuel injection amount (the fuel injection amount corresponding to the distance between the dashed line and the solid line in FIG. 4) required for generating the required torque in the main injection. The minimum fuel injection amount in the pre-injection indicated by the dashed line in FIG. 4 has characteristics of a gradual increase corresponding to the engine speed increase so as to compensate for the reduced number of the pre-injections, and is substantially constant when the engine speed is above a predetermined value. Further, the minimum fuel injection amount in the main injection has similar characteristics as the minimum fuel injection amount in the pre-injection. Therefore, the predetermined amount indicated by the solid line in FIG. 4 has characteristics of a gradual increase corresponding to the engine speed increase.

Thus, as indicated by the black circle in FIG. 4, the cylinder-cutoff operating mode is executed when the total fuel injection amount, set according to the engine load, falls below the predetermined amount because the main combustion becomes unstable. Thereby, the number of the cylinders to be supplied with the fuel is reduced from four to two, and therefore, as indicated by the white arrow in FIG. 4, the fuel injection amount per cylinder increases (here, substantially doubled) to reach the amount indicated by the white circle in FIG. 4. As a result, as described above, the pre-combustion with an enough heat release rate is caused at the predetermined timing before the top dead center in the compression stroke, and thereby, the main combustion is stabilized and the torque is stabilized.

Here, a condition in which the engine speed is higher than a predetermined speed may be included in determining whether to execute the cylinder-cutoff operating mode because problems, particularly a problem of instability of the main combustion, arise when the number of the pre-injections is needed to be reduced due to the high engine speed.

As described above, in the cylinder-cutoff operating mode, the fuel supply to two of the four cylinders in the engine 1 is stopped and only the other two cylinders are operated. Particularly, as shown in FIG. 5, in the in-line four cylinder engine 1 for performing combustion in the cylinders in an order of the first, the third, the fourth, and then the second, the fuel supplies to the second and third cylinders are stopped while the first and fourth cylinders are supplied with the fuel so that the active cylinders supplied with the fuel and the deactivated cylinders not supplied with the fuel among the cylinders 11a are alternated. Thus, one or more of the cylinders 11a are regularly deactivated, and therefore are effective in suppressing the degradation of NVH performance in the cylinder-cutoff operating mode.

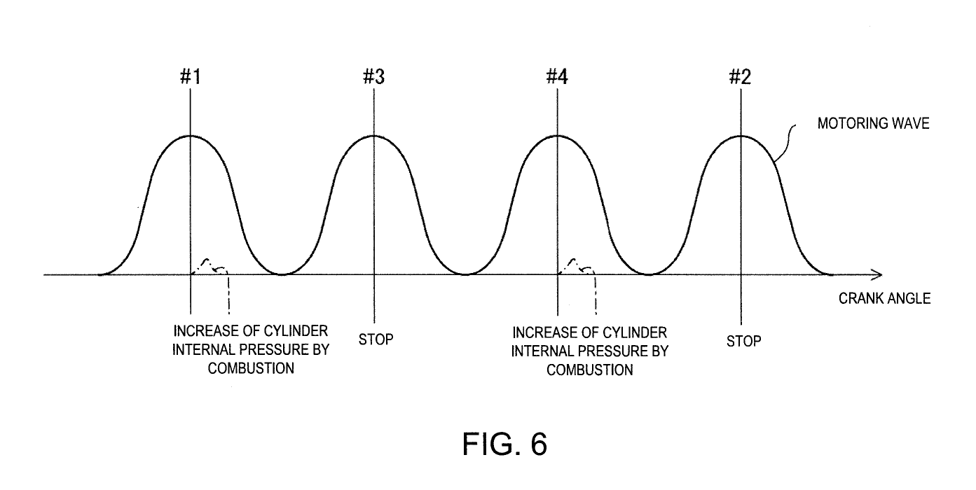

The diesel engine 1 is different from a spark ignition engine in that a motoring wave is formed, as indicated by the example of the indicator waveform in FIG. 6, because the throttle valve 36 is fully opened and, therefore, the compression of the intake air is performed in each of the cylinders 11a. On the other hand, the cylinder-cutoff operating mode is executed within the low load range where the total fuel injection amount falls below the predetermined amount as described above, and the cylinder internal pressure is minimally increased by the combustion as indicated by the dashed line in FIG. 6. Therefore, because the motoring waveform is dominant within the change of the indicator waveform in the cylinder-cutoff operating mode, the indicator waveform changes are substantially regular even when one or more of the cylinders 11a are deactivated. Thus, NVH performance can avoid degradation in the cylinder-cutoff operating mode.

When the required conditions for executing the cylinder-cutoff operating mode are not met due to, for example, an increase of the load during the cylinder-cutoff operating mode, the PCM 10 switches the mode from the cylinder-cutoff operating mode to the normal operation mode, that is, four cylinder operation. Then, when executing the cylinder-cutoff operating mode again, the cylinders 11a not to be supplied with the fuel are changed from the second and third cylinders in the previous cylinder-cutoff operating mode to the first and fourth cylinders. That is, the PCM 10 alternates the cylinders not to be supplied with fuel each time the cylinder-cutoff operation is executed. Thus, an excessive decrease in temperature inside the cylinders 11a due to the fuel supply being stopped in the cylinder-cutoff operating mode can be avoided in advance, and thereby it is effective in securing the ignition efficiency of the cylinders 11a, which are switched from a deactivated state to an activated state.

In other words, the engine 1 is a self-ignition diesel engine, therefore the temperatures inside the cylinders are extremely important in securing the ignition efficiency of the fuel. However, the temperatures inside the cylinders decrease as time lapses during the cylinder-cutoff operating mode because the combustion does not occur in the cylinders 11a not being supplied with the fuel. Therefore, the cylinders 11a not supplied with the fuel are alternated each time the cylinder-cutoff operating mode is executed so as to avoid the temperature inside the deactivated cylinders 11a from cooling down due to remaining in the deactivated state for effectively a prolonged period. Thus, the cylinder cut-off operating mode is effective in safely operating the engine 1.

Therefore, in the engine 1, the pre-combustion having the predetermined heat release rate at the predetermined timing before the top dead center in the compression stroke can be caused by performing the plurality of pre-injections before the main injection. Thus, the ignition efficiency in the low compression ratio engine 1 can be improved and the main combustion can be stabilized (see the solid lines in parts (a) and (b) of FIG. 3).

Further, when the load on the engine 1 is reduced and the fuel injection amount per cylinder falls below the predetermined amount, the fuel supply to some of the cylinders (here, two cylinders) is stopped to increase the fuel injection amount for each of the cylinders to be supplied with fuel. Therefore, the pre-combustion having the predetermined heat release rate is surely caused, and thereby the ignition efficiency can be improved even under the low load condition and the main combustion can be stabilized. Further, the total fuel injection amount is set lower, particularly in the low compression ratio, and therefore, the engine 1 is effective in stabilizing the main combustion by utilizing the cylinder-cutoff operating mode.

For the spark-ignition engine, the cylinder-cutoff operation causes the indicator waveform to be irregular compared to the normal operation because combustion is not carried out in only certain cylinders, and thereby NVH performance is degraded. On the other hand, when utilizing the diesel engine 1, the motoring wave is formed and the cylinder-cutoff operation mode is executed when the load on the engine 1 is low, therefore, the motoring waveform becomes dominant in the indicator waveform and the waveform becomes substantially regular. Further, the two-cylinder operation is effective in forming the indicator wave that is regular. As a result, NVH performance can avoid degradation even in the cylinder-cutoff operating mode. In addition, the degradation of NVH performance can further be suppressed when the cylinder-cutoff operating mode is executed while the rotation speed of the engine 1 is high.

Further, alternating the cylinders that are not supplied with fuel each time the cylinder-cutoff operating mode is executed suppresses the temperature decrease of the deactivated cylinders 11a and may be effective in safely operating the engine 1.

Note that, in the above embodiment, the cylinders in the deactivated state are changed each time the cylinder-cutoff operating mode is executed. However, if the temperatures inside the cylinders 11a not to be supplied with fuel may decrease due to, for example, remaining in the cylinder-cutoff operating mode for a prolonged period, the cylinders 11a not to be supplied with fuel may be switched during the cylinder-cutoff operating mode. In this case, the cylinders in the deactivated state may be switched by measuring or estimating the temperatures inside the cylinders 11a, or the cylinders may be switched based on the deactivated time period of the cylinders 11a.

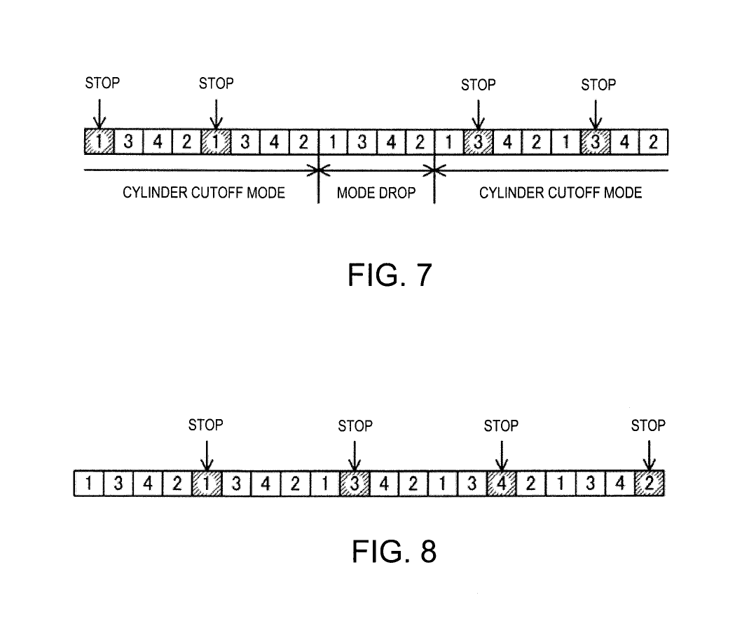

Further, in the above embodiment, a two-cylinder operation is utilized in the cylinder-cutoff operating mode. However, as shown in FIG. 7, only one cylinder may be deactivated and a three-cylinder operation may be utilized in the cylinder-cutoff operating mode. Further in this case, as shown in FIG. 7, alternating the deactivated cylinder 11a each time the cylinder-cutoff operating mode is executed is effective in suppressing the temperature decrease inside the cylinders. Further, the deactivated cylinder may be alternated during the cylinder-cutoff operating mode.

Further, as shown in FIG. 8, one of the cylinders may be deactivated at each predetermined cycle (here, cycle of every four) instead of setting the certain cylinder 11a to be deactivated in the cylinder-cutoff operating mode as shown in FIGS. 6 and 7. Thereby, the cylinder 11a to be deactivated is sequentially changed, and therefore the temperature decrease inside the certain cylinder 11a can be avoided.

Note that, the above described fuel injection mode is an example of implementing the present invention and it is not limited to this embodiment. For, example, the number of the pre-injections is not limited to three and may be increased or decreased within an appropriate range. Further, the number of the cylinders and the type of the engine 1 are not limited to those described in this embodiment.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A diesel engine for a vehicle, comprising:
an engine body to be mounted in the vehicle and having a plurality of cylinders that is supplied with fuel containing diesel fuel as its main component;
a plurality of fuel injection valves arranged in the engine body so as to be oriented toward the cylinders and for directly injecting the fuel into the cylinders, respectively; and
an injection control module for controlling a mode of injecting the fuel into the cylinders through the fuel injection valves;
wherein the injection control module sets a fuel injection amount per cylinder at least according to a load on the engine body, performs a main injection where the fuel is injected at near a top dead center in a compression stroke so as to cause a main combustion that is mainly triggered by a diffusion combustion, and performs, at least one, a pre-injection where the fuel is injected prior to the main injection so as to cause a pre-combustion having a peak heat release rate at a predetermined timing before the top dead center in the compression stroke; and
wherein the injection control module further executes a cylinder-cutoff operation mode in which a fuel supply to one or more of the plurality of cylinders is stopped when the engine body is under a low load condition and a fuel injection amount per cylinder is below a predetermined amount.

2. The diesel engine of claim 1, wherein the predetermined amount is set, under a condition that the fuel is supplied to all of the cylinders, based on a summation of a minimum injection amount of the at least one pre-injection required for causing the pre-combustion with a predetermined heat release rate and a minimum injection amount of the main injection required for causing a combustion torque corresponding to the load on the engine body by the diffusion combustion.

3. The diesel engine of claim 2, wherein a geometric compression ratio of the engine body is set within a range of 12:1 to below 15:1.

4. The diesel engine of claim 3, wherein the injection control module executes the cylinder-cutoff operation mode when a rotation speed of the engine body is above a predetermined value.

5. The diesel engine of claim 2, wherein, each time the cylinder-cutoff operation mode is executed, the injection control module alternates the one or more cylinders that are not to be supplied with the fuel.

6. The diesel engine of claim 2, wherein the injection control module executes the cylinder-cutoff operation mode when a rotation speed of the engine body is above a predetermined value.

7. The diesel engine of claim 1, wherein a geometric compression ratio of the engine body is set within a range of 12:1 to below 15:1.

8. The diesel engine of claim 7, wherein, each time the cylinder-cutoff operation mode is executed, the injection control module alternates the one or more cylinders that are not to be supplied with the fuel.

9. The diesel engine of claim 3, wherein the injection control module executes the cylinder-cutoff operation mode when a rotation speed of the engine body is above a predetermined value.

10. The diesel engine of claim 1, wherein, each time the cylinder-cutoff operation mode is executed, the injection control module alternates the one or more cylinders that are not to be supplied with the fuel.

11. The diesel engine of claim 1, wherein the injection control module executes the cylinder-cutoff operation mode when a rotation speed of the engine body is above a predetermined value.

12. A diesel engine for a vehicle, comprising:
an engine body to be mounted in the vehicle and having a plurality of cylinders that is supplied with fuel containing diesel fuel as its main component;
a plurality of fuel injection valves arranged in the engine body so as to be oriented toward the cylinders and for directly injecting the fuel into the cylinders, respectively; and
an injection control module for controlling a mode of injecting the fuel into the cylinders through the fuel injection valves;
wherein a geometric compression ratio of the engine body is set within a range of 12:1 to below 15:1;
wherein the injection control module sets a fuel injection amount per cylinder at least according to a load on the engine body, performs a main injection where the fuel is injected at near a top dead center in a compression stroke so as to cause a main combustion that is mainly triggered by a diffusion combustion, and performs at least one pre-injection where the fuel is injected prior to the main injection so as to cause a pre-combustion having a peak of heat release rate at a predetermined timing before the top dead center in the compression stroke;
wherein the injection control module further executes a cylinder-cutoff operation mode in which a fuel supply to one or more of the cylinders is stopped when the engine body is under a low load condition and the fuel injection amount per cylinder is below a predetermined amount; and
wherein the predetermined amount is set, under a condition that the fuel is supplied to all of the cylinders, based on a summation of a minimum injection amount of the at least one pre-injection required for causing the pre-combustion with a predetermined heat release rate and a minimum injection amount of the main injection required for causing a combustion torque corresponding to the load on the engine body by the diffusion combustion.
